(19) United States
(12) Patent Application Publication
(10) Pub. No.: US 2013/0218544 A1
(43) Pub. Date: Aug. 22, 2013

(54) PLASTIC FORMING METHOD

(71) Applicant: GM GLOBAL TECHNOLOGY OPERATIONS LLC, (US)

(72) Inventor: Albert EMRICH, Darmstadt (DE)

(73) Assignee: GM GLOBAL TECHNOLOGY OPERATIONS LLC, Detroit, MI (US)

(21) Appl. No.: 13/771,230

(22) Filed: Feb. 20, 2013

(30) Foreign Application Priority Data
Feb. 21, 2012 (DE) 10 2012 003 349.4

(51) Int. Cl. G06F 17/50

(52) U.S. Cl. CPC G06F 17/5009; G06F 17/5095
USPC 703/8; 703/6

(57) ABSTRACT

A method for plastically forming a plate is provided. The method includes simulating forming the plate based on a frictional parameter that locally varies.

### CROSS-REFERENCE TO RELATED APPLICATION

This application claims priority to German Patent Application No. 10 2012 003 349.4, filed Feb. 21, 2012, which is incorporated herein by reference in its entirety.

### TECHNICAL FIELD

The technical field relates to a method for plastically forming a plate, in particular into a vehicle body component, a computer program product with a computer program for implementing such a method, as well a device for simulating plastic forming

### BACKGROUND

During the manufacture of vehicle bodies, backing plates are subjected to plastic forming In order to be able to specify and especially to optimize these forming processes, it is known from in-house practice to simulate the latter, wherein the friction between the plate and a clamping and/or forming tool is taken into account. A global, uniform friction parameter had here previously been used as the basis.

At least one object herein is to improve the forming of plates, in particular into vehicle body components. In addition, other objects, desirable features and characteristics will become apparent from the subsequent summary and detailed description, and the appended claims, taken in conjunction with the accompanying drawings and this background.

### SUMMARY

An exemplary embodiment herein involves virtually simulating the process of plastically forming a plate in advance or during actual forming The simulation can be a finite-element simulation, for example. The forming can encompass deep-drawing, bending, pressing, stamping, rolling or the like. Within the meaning herein, a plate is understood as an extensive, flat initial component, for example, a sheet, for example, a metal sheet, such as a steel sheet. In an embodiment, the sheet is wound into a roll, a so-called “coil”, prior to forming

In-house practice has shown that forming processes are sensitive to friction between the plate and a clamping and/or forming tool, wherein the clamping tool is understood to involve one or two opposing contact surfaces for fixing the plate in place, and a forming tool is understood to involve one or two opposing contact surfaces for plastically forming the plate.

Friction depends especially on the plate-tool material pairing and a lubricant, and can be described by a friction parameter or specified in the simulation. Within the meaning herein, a friction parameter can be a static and/or sliding friction (constant) value or coefficient μ, which maps a normal force N onto a (maximum) static and/or static frictional force R, for example given a Newtonian friction according to R≦μN. The frictional value or coefficient can be constant or a function of the relative velocity and/or normal force or contact pressure between the plate and tool.

The frictional parameter depends in particular on a lubricant film thickness. Tests have shown that the frictional value usually decreases as lubricant film thickness increases up to a saturation value.

However, in-house practice has shown that the lubricant is not homogeneously distributed over the plate. In particular, a convexity can force lubricant in the coil toward the edge. In addition, gravity can cause lubricant to accumulate below given a vertical coil.

In particular such local fluctuations in lubricant film thickness can result in frictional parameters that vary locally, but in particular over the width and/or length of a plate. Taking a global, uniform frictional parameter as the basis instead may distort the simulation result, and, for example, cause the process robustness to be misjudged and/or process parameters to be incorrectly specified.

Therefore, one embodiment herein involves simulating the plastic forming of a plate, in particular into a vehicle body component, based on a frictional parameter, which varies locally, in particular over the width and/or length of a plate. As a result, the validity of the simulation can be increased, and the forming process can be improved based thereupon. In particular, the simulation can be used as a basis for specifying a lubricant, a lubricant quantity and/or a treatment for the plate and/or identifying the process robustness. For example, it can be provided based on the simulation that the plate be cleaned to remove lubricant and/or a microlubricating process be performed.

The frictional parameter variation can be locally discrete or continuous. In particular, the frictional parameter can be varyingly specified for different discrete, in particular equidistant, plate regions, which can be advantageous especially for FE simulations.

In one embodiment, the frictional parameter can vary stochastically. To this end, a value that can locally vary or remain constant over the plate can be specified in particular by a base value. One or more stochastic variables, in particular a random number and/or stochastic parameters, for example a standard deviation, can then be used to vary this base value from empirical measurements.

As explained above, the frictional parameter can vary in particular based on a locally varying lubricant distribution or locally varying lubricant film thicknesses. This is why the frictional parameter in one embodiment is determined based on a lubricant distribution that varies locally, in particular stochastically.

As explained above, the latter can be specified by a base value, which is varied by one or more stochastic variables. In particular, a virtual lubricant distribution can initially be specified, which exhibits an accumulation of lubricant at an edge of the plate so as to map the displacement of lubricant in the coil owing to the convexity. In a further development, this virtual lubricant distribution is specified by a quadratic function of the coil width. This virtual lubricant distribution or this base value that locally varies over the plate is then varied by one or more stochastic variable, for example by adding random numbers. The lubricant distribution taken as the basis for the simulation preferably corresponds to an actual lubricant distribution from a stochastic standpoint. In particular, this is taken to mean that the lubricant distribution serving as the basis for the simulation exhibits an average value and/or standard deviation corresponding to the average value or standard deviation of a measured, actual lubricant distribution.

When several plates are formed in succession using the same tool(s), lubricant can be transferred between the plates and tools. In one embodiment, the lubricant distribution is thus determined based on a simulated lubricant transfer between a clamping and/or forming tool and the plate. If this simulation of the lubricant transition reveals a stationary final state, the forming process is preferably simulated based upon this stationary final state.

In particular if a locally varying lubricant distribution was determined as explained above, a locally varying frictional parameter for simulating the plate forming process can be determined from the latter. In an embodiment, the frictional parameter is for this purpose empirically determined based on the lubricant distribution, in particular based on a strip tensile test, which maps a lubricant film thickness on a frictional parameter.

A computer program product according to an embodiment can in particular involve a preferably transportable or stationary data storage device, for example a CD, DVD, hard disk or the like, on which is stored a computer program that executes the process described above when running in a computer.

A device according to another embodiment exhibits a means for simulating forming based on a frictional parameter that locally varies, locally stochastically varying the frictional parameter, determining the frictional parameter based on a lubricant distribution that varies locally, in particular stochastically, defining a virtual lubricant distribution that exhibits a lubricant accumulation at one edge of the plate, determining the lubricant distribution based on a simulated lubricant transition between a tool and the plate, empirically determining the frictional parameter based on the lubricant distribution, in particular based on a strip tensile test, specifying a lubricant and/or lubricant quantity and/or identifying the same based on the simulation. Within the meaning herein, a means can here be implemented as hardware and/or software, especially via one or more storage media, central processing units and/or programs or program modules.

### BRIEF DESCRIPTION OF THE DRAWINGS

The various embodiments will hereinafter be described in conjunction with the following drawing figures, wherein like numerals denote like elements, and wherein:

FIG. 1 is a flowchart illustrating a method of plastically forming a plate according to an embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

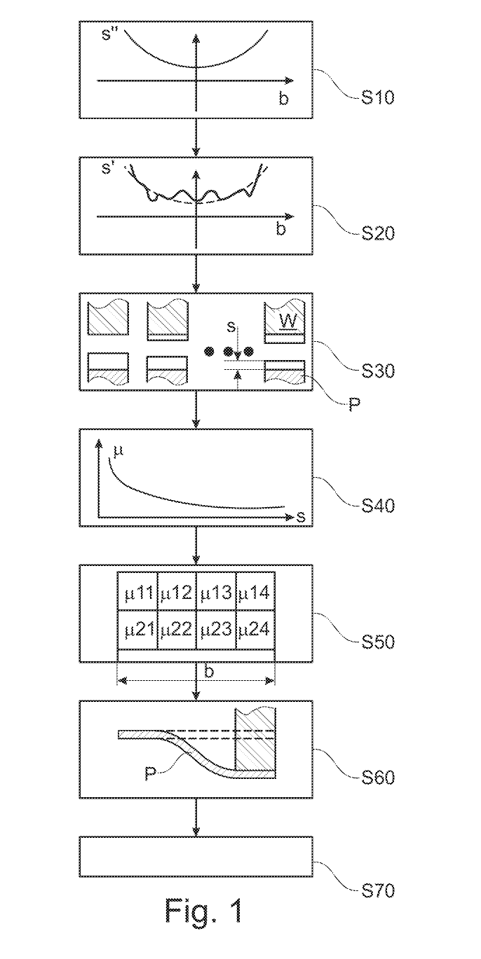

FIG. 1 shows steps S10 to S70 of a method of platically forming a plate according to an embodiment. The elements on FIG. 1 could equally also represent means of a device according to an embodiment, for example that can be implemented in the software via program modules and/or in the hardware via central processing units.

In a step or means S10, a virtual lubricant distribution s″(b), i.e., allocation of coil (width) positions b to lubricant film thicknesses s″, is first specified by a quadratic function of the coil width b of a plate P, which exhibits a lubricant accumulation s″(coil edge)>s″ (coil middle) at both edges of the plate P.

In step or means S20, random numbers are then added together to generate a stochastically varying lubricant distribution s′(b) from the latter. This perturbation is selected in such a way that stochastic parameters for the stochastically varying lubricant distribution s′(b), for example average values, standard deviations and the like, at least essentially coincide with those of an empirically measured lubricant distribution.

In step or means S30, lubricant transitions between a tool and the plate P are subsequently simulated, and then taken as the basis for a stationary lubricant distribution s(b), which arises in the process.

In step or means S40, a frictional parameter μ, for example a static or sliding frictional constant, is then determined based on this lubricant distribution (μ=μ(s(b))), which also varies in a locally stochastic manner due to the stochastic variation of the lubricant film thickness s over the coil width b. To this end, the lubricant distribution can in particular be mapped onto the frictional parameters based on a strip tensile test.

This is performed in step or means S50 for discrete areas of plate P. For example, the plate can be divided into discrete areas in the longitudinal and width direction b, for which a local frictional parameter μij is then respectively determined, as explained above, which varies stochastically from area to area.

The ensuing step or means S60 involves simulating the plastic forming of plate P into a vehicle body part based on this frictional parameter μij.

This simulation can be used as a basis in step or means S70 in particular for specifying a lubricant, a lubricant quantity and/or a treatment of the plate and/or identify the process robustness. For example, it can be determined whether the plate should be cleaned or degreased beforehand, in particular in a plate washer, and/or whether a microlubricating process should be performed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A method for plastically forming a plate (P), in particular into a vehicle body component, wherein forming is simulated (S60) based on a frictional parameter (μ) that locally varies (μᵢⱼ≠μ_{(u≠i)(n≠j)}).

2. The method according to claim 1, wherein the frictional parameter (μ) varies in a locally stochastic manner (S50).

3. The method according to one of the preceding claims, wherein the frictional parameter (μ) is determined based on a lubricant distribution (s(b)) (S40), which varies locally, in particular stochastically (S20).

4. The method according to the preceding claim, wherein a virtual lubricant distribution (s″(b)) on an edge of the plate (P) exhibits a lubricant accumulation (S10).

5. The method according to one of preceding claims 3 to 4, wherein the lubricant distribution (s′(b)) is determined based on a simulated lubricant transfer between a tool and the plate (P) (S30).

6. The method according to one of preceding claims 3 to 5, wherein frictional parameter (μ) is empirically determined based on the lubricant distribution (s(b)), in particular based on a strip tensile test (S40).

7. The method according to one of the preceding claims, wherein the simulation is used as the basis for specifying a lubricant, a lubricant quantity and/or a treatment of the plate (P), and/or identifying the process robustness (S70).

8. A computer program product, on which is stored a computer program is set up to execute a process according to one of the preceding claims when running in a computer.

9. A device for simulating the plastic forming of a plate, in particular into a vehicle body component, wherein the device is set up to execute a process according to one of the preceding claims 1 to 7.
